(19) United States
(12) Patent Application Publication
(10) Pub. No.: US 2003/0225734 A1
(43) Pub. Date: Dec. 4, 2003

(54) Interactive diagram in markup language page

(76) Inventor: Evan Witt, Chicago, IL (US)

Correspondence Address: Finnegan, Henderson, Farabow,, Garrett & Dunner, L.L.P., 1300 I Street, N.W., Washington, DC, 20005-3315, US

(21) Appl. No.: 10/164,192

(22) Filed: Jun. 4, 2002

(51) Int. Cl. G06F 7/00

(52) U.S. Cl. 707/1

(57) ABSTRACT

A server computer provides a markup page and sends the markup page to a client computer for providing a diagram on a screen. The markup page has a first array with a first number set, a second array with a second number set, and a third array with a third number set. The sets form functions. Selector code is inserted into the markup page for providing a selector for user interaction with the diagram. Diagram code is inserted into the page for providing the diagram based on the selection.

### BACKGROUND

1. Technical Field

The present invention generally relates to data processing. More specifically, the present invention relates to computer systems, computer programs, and methods for client server communication over Internet protocol and pages in markup languages.

2. Related Art

Data is often available as a function Y=f(X) of a first set of numbers (Y) over a second set of numbers (X), such as stock values over time. Humans often desire to view the data through a graphical overview of the function instead of reviewing exact numbers. A graphical overview, such as a diagram using coordinate systems, may be convenient for presenting a function to a human user.

Data is often communicated from a server computer to a client computer over an Internet protocol network (e.g., TCP/IP). In such cases, the server computer provides the diagram as a graphical image in a pixel format (e.g., gif, jpeg). Usually, the graphical image is associated with a page in a markup language (e.g., HTML, XML). A client computer with a browser presents the graphical image to the user on a screen. However, client server communications of graphical images frequently exhibit a variety of technical problems. One exemplary technical problem is that the server computer needs to operate software that generates the graphical image from the number sets X and Y, such as through Common Gateway Interface (CGI) or Active Server Page (ASP). Transmitting a graphical image requires more bandwidth then sets of numbers.

Another limitation is that the client computer can modify the appearance of the graphical image only when the number sets X and Y remain unchanged, for example, when modifying the overall size of the graphical image. Modifying even a single number (of X or Y) requires re-conversion and retransmission of a complete graphical image. The modification can result from user interaction at the client computer or data modification at the server computer.

Thus using existing graphical images techniques is inefficient and there is a need for a technical solution to the problem of presenting manipulated graphical images.

### SUMMARY

In accordance with one embodiment consistent with the present invention, a server computer provides a markup page and sends the markup page to a client computer for providing a diagram on a screen. The method comprising inserting into the page, a first array with a first number set (n), a second array with a second number set (q), a third array with a third number set (t). The first set (n) and third set (t) form a first function (n=f(t)). The second set (q) and the third set (t) form a second function (q=f(t)). The method further comprises, inserting selector code for providing a selector into the page, the code for interacting with a user to receive a selection of selectively the first and the second function. The method further comprises inserting diagram code for providing a diagram for the first function or for the second function depending on the selection.

In accordance with another embodiment consistent with the present invention, providing a markup page provided by a server computer and adapted to control a browser on a client computer. The markup page comprising a first array with a first number set (n), a second array with a second number set (q), a third array with a third number set (t), wherein the first set (n) and third set (t) form a first function (n=f(t)) and the second set (q) and the third set (t) form a second function (q=f(t)). The markup page further comprises selector code for providing an onscreen selector to interact with a user to receive a selection of selectively the first and the second function. The markup page further comprises diagram code for providing an on-screen diagram for the first function or for the second function depending on the selection.

In accordance with another embodiment consistent with the present invention, providing a server computer sending a markup page to a client computer. The client computer interprets a page in a browser to provide an on-screen diagram. The server computer inserts into the page a first array with a first number set (n), a second array with a second number set (q), a third array with a third number set (t), wherein the first set (n) and third set (t) form a first function (n=f(t)) and the second set (q) and the third set (t) form a second function (q=f(t)) selector code for providing a selector into the page, the code for interacting with a user of the client computer to receive a selection of selectively the first and the second function and diagram code for providing the diagram for the first function or for the second function depending on the selection.

In accordance with another embodiment consistent with the present invention, providing a computer program product embodied on a computer usable medium for causing a server computer to provide a markup page and to subsequently send the markup page to the client computer for displaying a diagram on screen. The computer program product comprising instructions to insert into the page, a first array with a first number set (n), a second array with a second number set (q), a third array with a third number set (t), wherein the first set (n) and third set (t) form a first function (n=f(t)) and the second set (q) and the third set (t) form a second function (q=f(t)). The computer program product further comprising instructions to insert selector code into the page, for providing a selector, the selector code for interacting with a user to receive a selection of selectively the first and the second function. The computer program product further comprising instructions to insert diagram code into the page, for providing a diagram for the first function or for the second function depending on the selection.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the figures,

FIG. 1 illustrates a simplified block scheme of a computer system;

FIG. 2 illustrates an overview about number sets;

FIG. 3 illustrates a first diagram;

FIG. 4 illustrates a selector displayed together with the first diagram;

FIG. 5 illustrates a second diagram;

FIG. 6 illustrates a selector displayed together with the second diagram;

FIG. 7 illustrates a modified diagram that is derived from the second diagram;

FIG. 8 illustrates an overview about server/client computers, a method, and code to implement the present invention;

FIG. 9 illustrates a simplified flow chart of a method of the present invention;

FIG. 10 illustrates a simplified action chart for communication between server and client computers;

FIG. 11 illustrates a two-graph diagram for an exemplary call center application;

FIG. 12 illustrates a magnified portion of the diagram representing a limited time period; and

FIG. 13 illustrates the magnified portion after data modification by the user.

### DETAILED DESCRIPTION

The present invention is directed to interactive diagram pages in markup languages. In certain embodiments of the present invention, graph generation is shifted from the server computer to the client computer. The server provides a markup language page with number sets (e.g., X, Y) in combination with code for providing the diagram. As a result, in certain embodiments, the server computer no longer needs to operate software that generates the graphical image. The graphic software on the client computer may be part of a commercially available browser. Thus the server may transmit number sets for use with the graphic software, instead of graphical images, to the client.

In the event of modifications, re-conversion and re-transmission of the complete pixel graph is no longer required in certain embodiments of the present invention. In case of modifications on the client computer, client communication with the server is not required. When the user (of the client computer) modifies data points, the client computer may adjust the diagram without extra communication. The page contains substantially enough information (i.e. data and code) so that communication with a server is not required.

Computer System in General

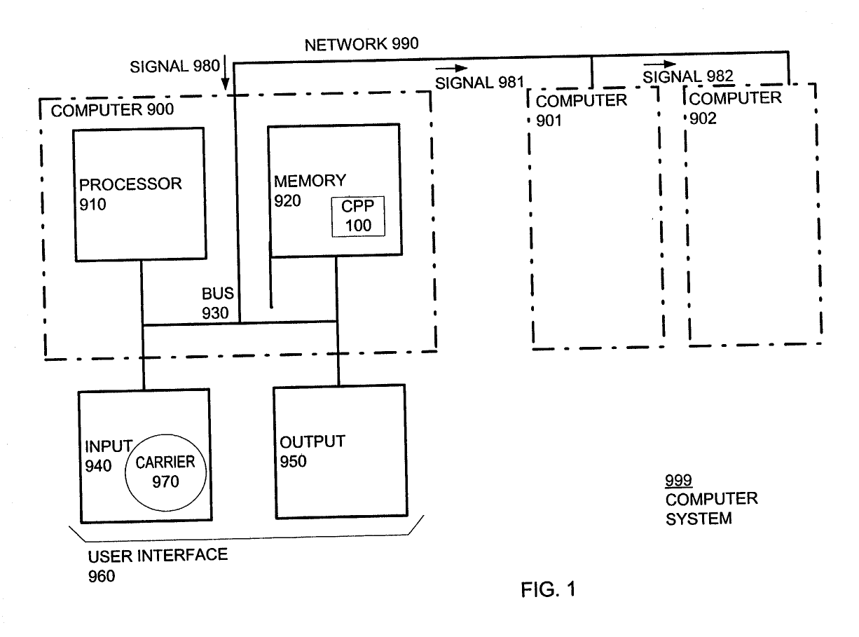

FIG. 1 illustrates a simplified block scheme of the inventive computer network system 999 having a plurality of computers 900, 901, 902 (or 90q, with q=0 . . . Q−1, Q any number). Computers 900-902 are coupled via inter-computer network 990. Computer 900 comprises processor 910, memory 920, bus 930, and, optionally, input device 940 and output device 950 (I/O devices, user interface 960). As illustrated, the invention is present by computer program product (CPP) 100, program carrier 970 and program signal 980, collectively “program”.

In respect to computer 900, computers 901 and 902 are sometimes referred to as “remote computers,” computers 901 and 902 may be, for example, a server, a router, a peer device or other common network node, and typically comprises many or all of the elements described relative to computer 900. Hence, elements 100 and 910-980 in computer 900 collectively illustrate also corresponding elements 10q and 91q-98q (shown for q=0) in computers 90q.

Computer 900 may be, for example, a conventional personal computer (PC), a desktop and hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer or other such computers known in the art.

Processor 910 may be, for example, a central processing unit (CPU), a micro-controller unit (MCU), digital signal processor (DSP), or other such processors known in the art.

Memory 920 symbolizes elements that temporarily or permanently store data and instructions. Although memory 920 is conveniently illustrated as part of computer 900, memory function can also be implemented in network 990, in computers 901 and 902 and in processor 910 (e.g., cache, register), or elsewhere. Memory 920 can be a read only memory (ROM), a random access memory (RAM), or a memory with other access options. Memory 920 is physically implemented by computer-readable media, such as, for example: (a) magnetic media, like a hard disk, a floppy disk, or other magnetic disk, a tape, a cassette tape; (b) optical media, like optical disk (CD-ROM, digital versatile disk—DVD); (c) semiconductor media, like DRAM, SRAM, EPROM, EEPROM, memory stick, or by any other media, like paper.

Optionally, memory 920 is distributed across different media. Portions of memory 920 can be removable or non-removable. For reading from media and for writing in media, computer 900 uses devices well known in the art such as, for example, disk drives, tape drives.

Memory 920 stores support modules such as, for example, a basic input output system (BIOS), an operating system (OS), a program library, a compiler, an interpreter, and a text-processing tool. Support modules are commercially available and can be installed on computer 900 by those of skill in the art. For simplicity, these modules are not illustrated.

CPP 100 comprises program instructions and—optionally—data that cause processor 910 to execute method steps of the present invention. Method steps are explained with more detail below. In one embodiment, CPP 100 defines the operation of computer 900 and its interaction in network system 999. CPP 100 can be available as source code in any programming language, and as object code (“binary code”) in a compiled form. CPP 100 may be used in connection with any of the above support modules (e.g., compiler, interpreter, operating system). Although CPP 100 is illustrated as being stored in memory 920, CPP 100 can be located elsewhere, such as in carrier 970.

Carrier 970 is illustrated outside computer 900. For communicating CPP 100 to computer 900, carrier 970 is conveniently inserted into input device 940. Carrier 970 is implemented as any computer readable medium, such as a medium largely explained above (cf. memory 920). Generally, carrier 970 is an article of manufacture comprising a computer readable medium having computer readable program code means embodied therein for executing the method of the present invention. Further, program signal 980 can also embody computer program 100. Signal 980 travels on network 990 to computer 900.

In one embodiment, CPP 100, program carrier 970, and program signal 980 in connection with computer 900. In another embodiment, program carriers 971 and 972 (not shown) and program signals 981 and 982 embody computer program products (CPP) 101 and 102 to be executed by processors 911 and 912 (not shown) in computers 901 and 902, respectively.

Input device 940 symbolizes a device that provides data and instructions for processing by computer 900. For example, device 940 is a keyboard, a pointing device (e.g., mouse, trackball, cursor direction keys), microphone, joystick, game pad, scanner, and disk drive. Although the examples are devices with human interaction, device 940 can also operate without human interaction, such as, a wireless receiver (e.g., satellite dish or terrestrial antenna), a sensor (e.g., a thermometer), a counter (e.g., goods counter in a factory). Input device 940 can serve to read carrier 970.

Output device 950 symbolizes a device that presents instructions and data that have been processed. For example, a monitor or a display, (cathode ray tube (CRT), flat panel display, liquid crystal display (LCD), speaker, printer, plotter, vibration alert device. Similar as above, output device 950 communicates with the user, but it can also communicate with further computers. Input device 940 and output device 950 can be combined to a single device; any device 940 and 950 can be optionally provided.

Bus 930 and network 990 provide logical and physical connections by conveying instruction and data signals. While connections inside computer 900 are conveniently referred to as “bus 930,” connections between computers 900-902 are referred to as “network 990.” Optionally, network 990 comprises gateway computers that specialize in data transmission and protocol conversion. Devices 940 and 950 are coupled to computer 900 by bus 930 (as illustrated) or by network 990 (optional). While the signals inside computer 900 are mostly electrical signals, the signals in network are electrical, magnetic, optical or wireless (radio) signals.

Networking environments (as network 990) are commonplace in offices, enterprise-wide computer networks, intranets and the Internet (i.e. world wide web). The physical distance between a remote computer and computer 900 is not important. Network 990 can be a wired or a wireless network. Network implementations of network 990 may be a local area network (LAN), a wide area network (WAN), a public switched telephone network (PSTN); a Integrated Services Digital Network (ISDN), an infra-red (IR) link, a radio link, such as Universal Mobile Telecommunications System (UMTS), Global System for Mobile Communication (GSM), Code Division Multiple Access (CDMA), or satellite link.

Transmission protocols and data formats are known, for example, as transmission control protocol/internet protocol (TCP/IP), hyper text transfer protocol (HTTP), secure HTTP, wireless application protocol, unique resource locator (URL), a unique resource identifier (URI), hyper text markup language HTML, extensible markup language (XML), extensible hyper text markup language (XHTML), wireless application markup language (WML), Standard Generalized Markup Language (SGML) etc.

Interfaces coupled between the elements are also well known in the art. For simplicity, interfaces are not illustrated. An interface can be, for example, a serial port interface, a parallel port interface, a game port, a universal serial bus (USB) interface, an internal or external modem, a video adapter, or a sound card. Computer and program are closely related. As used hereinafter, phrases, such as “the computer provides” and “the program provides”, are convenient abbreviation to express actions by a computer that is controlled by a program.

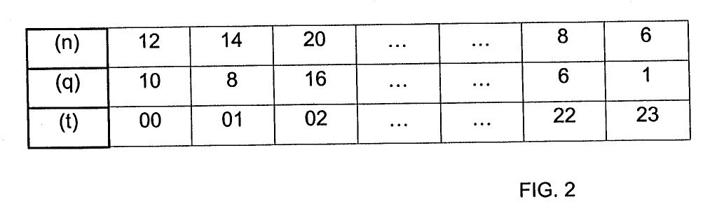

FIG. 2 illustrates an overview of number sets: first set (n), second set (q) and third set (t). In one embodiment, number set (n) stands for calls to a telephone call center (CALLS), number set (q) stands for abandoned calls (ABAND) to the call center, and number set (t) stands for the time in hours (TIME e.g., t=1 from 01:00 AM to 01:59 AM). The functions created from the number sets are first function n=f(t) and second function q=f(t).

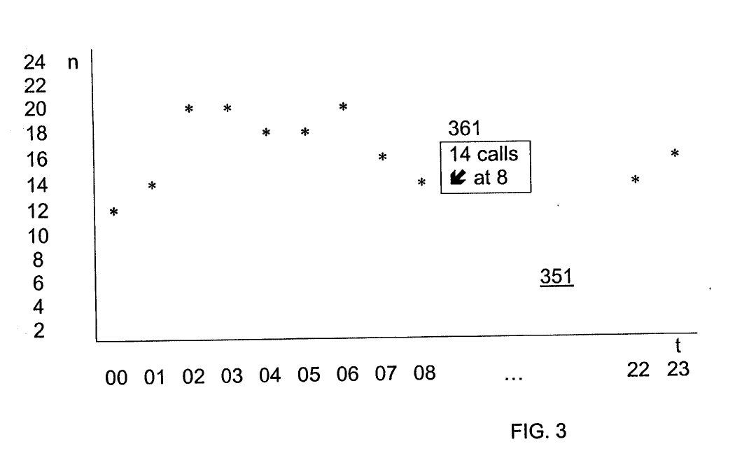

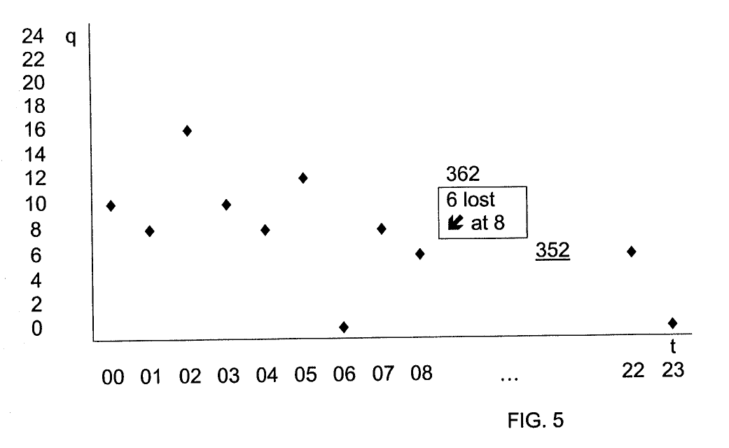

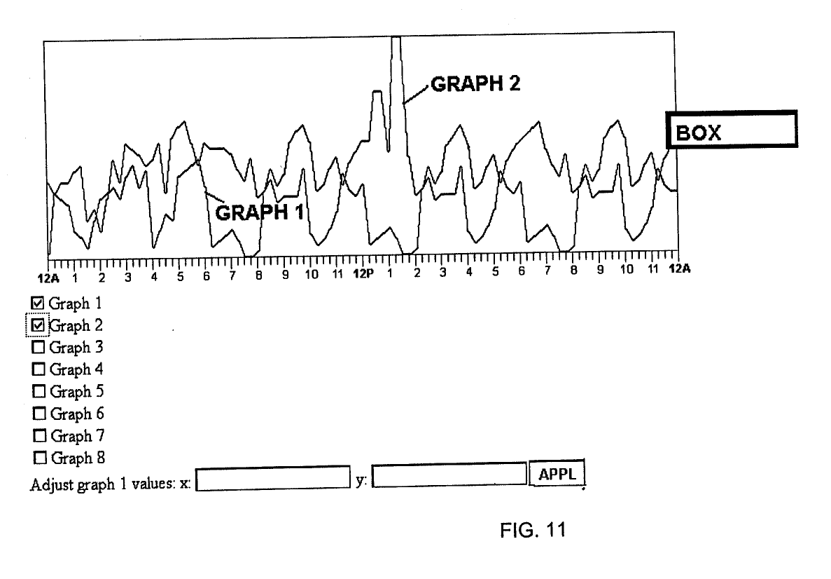

FIGS. 3-6 illustrate first diagram 351 and second diagram 352 in combination with selectors 340/370. Both diagrams 351 and 352 have an abscissa axis with the third number set (t) and an ordinate axis with the first number set (n) and the second number set (q), respectively. In one embodiment, functional number pairs are symbolized as an asterisk in diagram 351 with n=f(t) of FIG. 3 and a diamond in diagram 352 with q=f(t) of FIG. 5. Other display options can be accomplished, for example: bar graph, continuous line graph (i.e., points connected for FIG. 11), distinction by colors, pie chart, circle diagram, split pie chart (cf Plattner et al.).

Selector 340 is conveniently illustrated with the names of the functions (e.g., CALLS for n=f(t) and ABAND for q=f(t)) and the diagram symbol (e.g., asterisk or diamond). The selected function is indicated in a double-line frame. Other selector options can be accomplished, for example by radio buttons, check boxes, input field for numerical values, or hyperlinks.

FIGS. 3 and 5 also illustrate the optional feature display-numbers-on-mouse-over by boxes. In the box, an arrow (optional) points to the symbol for the number pair. The box indicates at least one number (e.g., n or t; here n and t) and—optionally—indicates text (e.g., “calls at”, “lost at”)

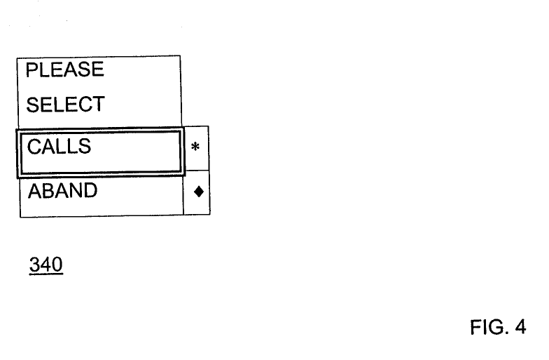

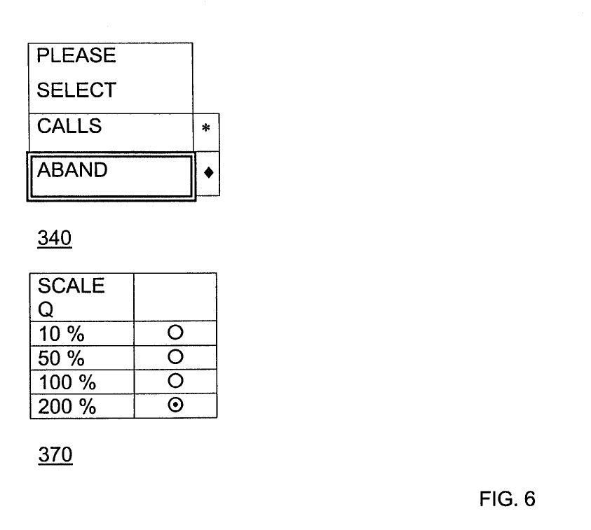

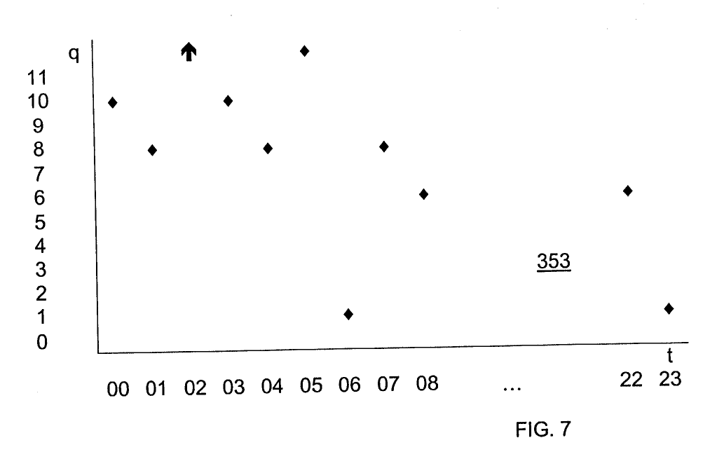

FIGS. 3-4 illustrate first diagram 351 of the first function CALLS n=f(t) in combination with selector 340 where “CALLS” is being selected by default. The mouse over box indicates n=14 for t=8. FIGS. 5-6 illustrate second diagram 352 of the second function ABAND q=f(t) in combination with selector 340 where “ABAND” has been selected by the user. Also illustrated is scale selector 370 (e.g., with radio buttons). The user has selected 200 percent for number set (q). The next diagram (FIG. 7) is presented with a 200 percent scaling. The number set of q remains the same. In an alternate embodiment a different type of scaling can be applied, for example, logarithmic scaling.

FIG. 7 illustrates modified diagram 353 that is derived from diagram 352. The ordinate axis (number set (q)) has been stretched without changing the numbers. The pair (2,16) is out of display and therefore indicated by an arrow. Due to the scaling, the other number pairs are presented over a larger display area then in diagram 352 (FIG. 6), thus providing an improved presentation to the user.

Stretching (or shrinking) (e.g. 10% or to 15%) is applicable to the ordinate axis (e.g., n or q), to the abscissa axis or to both axes. The value range can be modified as well. For example, further selectors optionally assist the user to indicate a time range between t=0 and t=12 (midnight and noon). Optionally, the user selection instructs the browser to display data at higher granularity (e.g., quarter of hours) in the page and to adjust the display resolution at the client. All these options are executable on the client; interactions with the server are not required. It is also possible to actually change the data in the client and to generate new data. For example, a further diagram could indicate the ratio between q and n as the ratio ABAND/CALL. Using further selectors, the user could switch to enhanced presentations, for example, to a diagram with the ratio n/q as a function of t or tables that indicate the actual numbers.

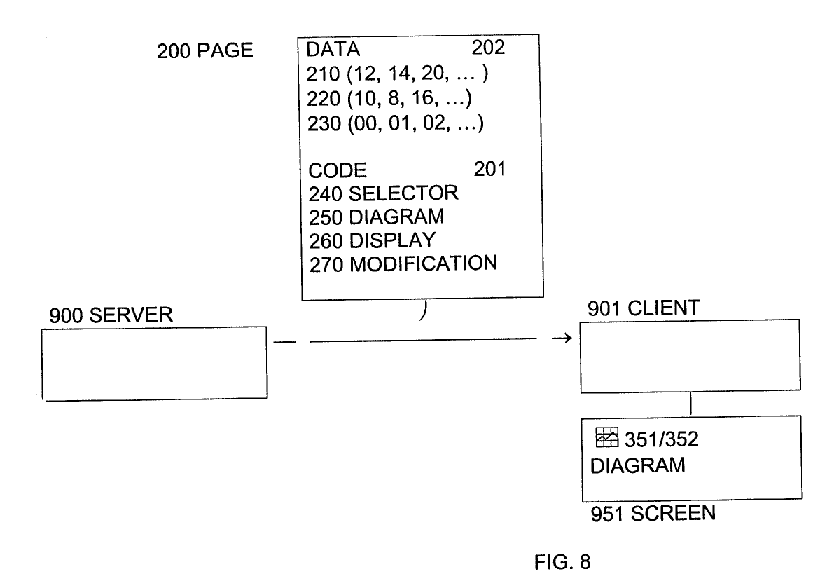

FIG. 8 illustrates an overview of server computer 900 communicating markup page 200 to client computer 901. The operation method as well as data 210-230 (page portion 202) and code 240-270 (page portion 201). As illustrated, computer 900 sends page 200 to computer 901; computer 901 controls screen 951 to provide, for example, diagrams (e.g. 351/352/353) and selectors (e.g., 340, 370). In one embodiment, the communication medium is the Internet.

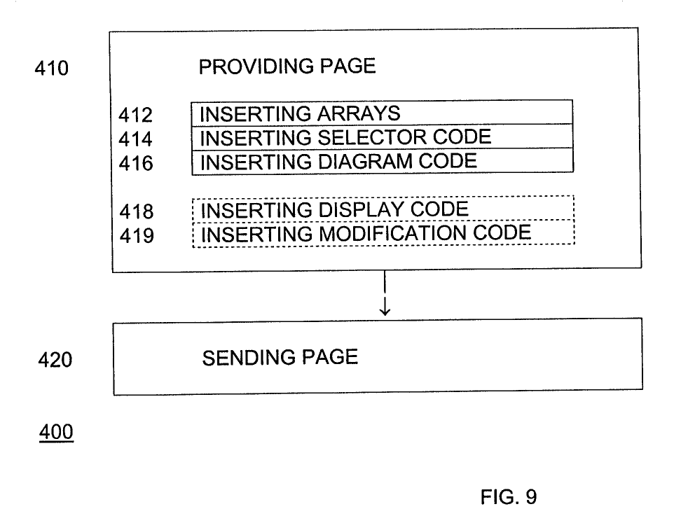

FIG. 9 illustrates a simplified flow chart of method 400 of the present invention. The sequential flow of the steps has been shown for ease of illustration; the steps are not necessarily sequential operations and can also be executed in parallel. Server computer 900 provides markup page 200 (step 410). Server computer 900 sends markup page 200 to client computer 901 to provide the diagram on screen 951 (step 420). Method 400 is characterized in that step 410 comprises inserting arrays 412 and inserting code 414-416.

When inserting arrays 412, computer 900 inserts (into page 200), first array 210 with first number set (n), second array 220 with second number set (q), and third array 230 with third number set (t). First set (n) and third set (t) form first function n=f(t), and second set (q) and third set (t) form second function q=f(t).

When inserting code 414, computer 900 inserts (into page 200) selector code 240 for providing selector 340 that is code for interacting with the user to receive a selection of the first function or the second function. When inserting code 416, computer 900 inserts (into page 200) diagram code 250 for providing diagram 351 and 352 for the first function or for the second function depending on the selection. Markup page 200 is provided in a browser interpretable language, for example, in HTML, DHTML, XML (cf. FIG. 1) in combination with scripts (e.g., JavaScript).

One embodiment includes a display-numbers-on-mouse-over feature. In a display-numbers-on-mouse-over feature, providing page 200 includes inserting code 418, such as display code 260 (FIG. 8) for displaying an indicator box 361 and 362 (FIGS. 3, 5) indicating a particular number when the user moves a pointing device over the diagram 351 and 352. The particular number corresponds to the position of the pointing device in the diagram 351 and 352.

One embodiment includes a modification feature for providing page 200 by inserting code 419, such as modification code 270 (FIG. 8) such that when activated by the user, executes an action selected from the group of stretching or shrinking a coordinate axis of the diagram 351 and 352; scaling the numbers in the first array 210, second array 220 or third array 230; and setting start and end borders for limiting display to sub-sets of the functions (e.g. functions in time from midnight to noon).

One embodiment includes a coordinate system feature. Inserting code 416, includes inserting diagram code 250. Code 250 is conveniently inserted to for a Cartesian coordinate system (e.g., perpendicular abscissa/ordinate axes) or a polar coordinate system (e.g., angle and radius).

One embodiment includes a reference diagram feature. Taking array 210 (n=f(t)) as a convenient example, statistics for consecutive days are displayed in a single diagram, where data for TODAY references to data for YESTERDAY in different colors, line style, texture, or shape.

One embodiment includes an array reservoir feature. One embodiment may include 3 arrays such as 210, 220 and 230. Another embodiment may include 2 array combinations to first and second functions. Another embodiment may provide page 200 with arrays of data for 10 diagrams but simultaneously show only 3 diagrams. Page 200 provides a data reservoir of arrays, from which client computer 901 displays diagrams that are based on a selection from the reservoir.

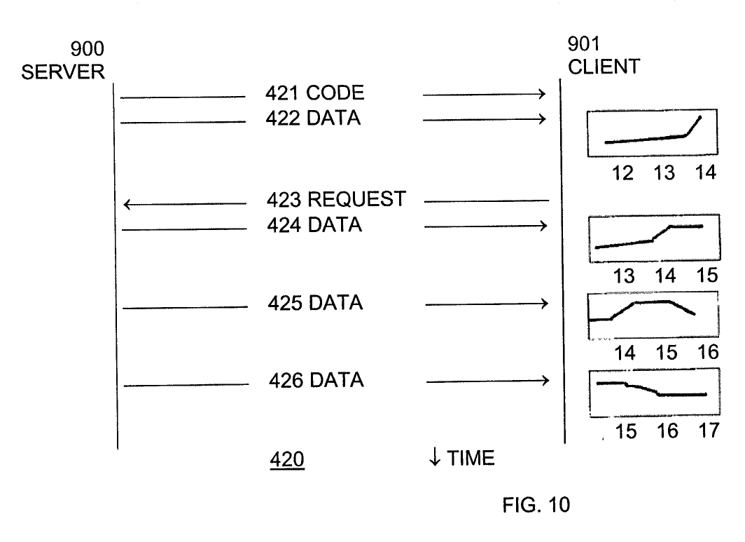

One embodiment includes a page-splitting feature, where server computer 901 sends portions 201 and 202 of page 200 at different time points (FIG. 10). One embodiment includes an update feature, where server computer 901 resends updates of data portion 202 periodically, on request, and/or conditionally (FIG. 10).

FIG. 10 illustrates a simplified action chart for communication between server computer 900 (left) and client computer 901 (right). Vertical lines symbolize computers 900 and 901. Horizontal arrows symbolize sending a page (FIG. 9) with exemplary events executed at consecutive time points (e.g., t=14 to t=17 standing for afternoon hours). Simplified diagrams show stock prices at time periods from 12 to 14, 13 to 15, 14 to 16 and 15 to 17. The arrows on the right symbolize sending code portion 201 including selector code 240 and with diagram code 250 (FIG. 8), and sending data portion 202 with arrays 210/220/230.

Computer 901 performs sending code portion and sending data portion at different time points. In one embodiment, code is sent prior to data. In another embodiment data is sent prior to code. Automatic sending alleviates the wait during a request. Optionally, sending a data portion is repeated upon receiving a request from client computer 900.

In one embodiment, sending data portion is repeated periodically, such as every hour. In another embodiment, sending data portion is repeated under a predefined condition detected by the application on server computer 900, for example, when the stock price passes a predefined threshold. Inserting selector code 240 and inserting diagram code 250 may be performed by loading predefined code components from a library, such as a from a tag library.

FIGS. 11-13 and the APPENDIX illustrate a further example for a call center application. The figures are exemplary screen shots, and APPENDIX provides exemplary code and comments. In FIGS. 11-13, lines, referred to as “graphs”, connect data points of the functions. The ordinate axis is the number of calls (“volume”); the abscissa axis is the time from midnight (“12A”) to midnight (“12A”). FIG. 11 illustrates that the user has checked graphs 1 and 2 from potential graphs 1-8. Graphs 1 and 2 indicate the functions “Actual Volume over Time” and “Forecasted Volume over Time”, respectively. In the example, the graphs would be color-coded. The BOX corresponds to indicator box 361 (e.g. FIG. 3) and reads as:

11:30P-11:45P

Actual Volume: 12 calls

Forecasted Volume: 17 calls

referring to both graphs.

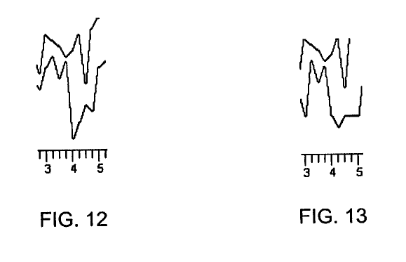

FIG. 11 also illustrates an input field (with confirmation button “APPL”) to adjust single data points of graph 1 (as a non-limiting example, adjusting further graphs possible as well). FIG. 12 illustrates (3 to 5 in the morning) a magnified portion of FIG. 11 representing a limited time period. The user has not yet operated the input fields. FIG. 13 illustrates a magnified portion corresponding to FIG. 12. The user has operated input fields and GRAPH 1 has changed; GRAPH 2 remains unchanged.

In APPENDIX, comments are provided in paragraphs with *** and in endnotes. For convenience, number sequences are abbreviated and partly omitted. Where convenient, the comments refer to features introduced above. The code is provided in JavaScript and HTML, well known to those of skill in the art.

Although various embodiments are shown, one skilled in the art will appreciate that all or part of the methods and system consistent with the present invention may appreciate that the methods and systems consistent with the present invention may contain additional or different components. Other embodiments or the invention will be apparent to those skilled in the art form consideration of the specification and practice of the invention disclosed herein. It is intended that the specification and examples be considered as exemplary only, with a true scope and sprit of the invention being indicated by the following claims.

[image]

[image]

[image]

[image]

[image]

[image]

[image]

[image]

[image]

1. A communication method in a network involving a server and a client, the method comprising:
providing a markup page;
sending the markup page to a client computer;
inserting into the markup page, a first array with a first number set (n), a second array with a second number set (q), a third array with a third number set (t), wherein the first set (n) and third set (t) form a first function (n=f(t)) and the second set (q) and the third set (t) form a second function (q=f(t));
inserting selector code for providing a selector into the markup page, the code for interacting with a user to receive a selection of selectively the first and the second function;
inserting diagram code for providing a diagram for the first function or for the second function depending on the selection; and
providing a diagram on a screen.

2. The method of claim 1, wherein providing the markup page further comprises inserting display code for displaying a box that indicates a particular number when the user moves a pointing device over the diagram, wherein the particular number corresponds to the position of the pointing device in the diagram.

3. The method of claim 1, wherein providing the markup page further comprises inserting modification code that when activated by the user, executes an action selected from the group of stretching a coordinate axis of the diagram, shrinking a coordinate axis of the diagram, scaling the numbers in the first array, second array or third array or setting start, and end borders for limiting display to sub-sets of the functions and provide linear-to-logarithmic or logarithmic-to-linear conversion.

4. The method of claim 1, wherein the functions have arrays selected from the group of stock price, call number, monetary value, temperature, date, hour, nominal number, and ordinal number.

5. The method of claim 1, wherein inserting diagram code comprises inserting code for a Cartesian coordinate system.

6. The method of claim 1, wherein inserting diagram code comprises inserting code for a polar coordinate system.

7. The method of claim 1, wherein inserting diagram code comprises inserting code for visualizing a scale by a reference to a graphic image file.

8. The method of claim 1, wherein sending the markup page comprises:
sending a code portion of the page with the selector code and with the diagram code, and
sending a data portion of the page with the arrays.

9. The method of claim 8, wherein sending code portion and sending data portion are performed at different time points.

10. The method of claim 9, wherein sending code portion is performed prior to sending data portion.

11. The method of claim 9, wherein sending data portion is repeated upon receiving a request from the client computer.

12. The method of claim 9, wherein sending data portion is repeated periodically.

13. The method of claim 9, wherein the step sending data portion is repeated under a predefined condition.

14. The method of claim 1, wherein inserting diagram code comprises providing code for simultaneously providing a reference graph in the diagram, the reference graph using further number sets.

15. The method of claim 14, wherein the reference graph distinguishes from the selected function by line style, color, texture, or shape.

16. The method of claim 1, wherein inserting first, second and third array comprises inserting further arrays to form a reservoir.

17. The method of claim 16, wherein inserting diagram code comprises providing diagram code for further diagrams that use numbers from the reservoir.

18. The method of claim 1, wherein inserting selector code and inserting diagram code are performed by loading code components from a library.

19. The method of claim 18, wherein the library is a tag library.

20. The method of claim 1, wherein inserting diagram code comprises providing code for diagrams selected from the group of a bar chart, a column chart, a stacked bar chart, a stacked column chart, and a pie chart.

21. A markup page provided by a server computer and adapted to control a browser on a client computer, the page comprising:
a first array with a first number set (n), a second array with a second number set (q), a third array with a third number set (t), wherein the first set (n) and third set (t) form a first function (n=f(t)) and the second set (q) and the third set (t) form a second function (q=f(t));
selector code for providing an on-screen selector to interact with a user to receive a selection of selectively the first and the second function; and
diagram code for providing an on-screen diagram for the first function or for the second function depending on the selection.

22. The markup page of claim 21, further comprising display code for displaying an on-screen box indicating a particular number when the user moves a pointing device over the diagram, wherein the particular number corresponds to the position of the pointing device in the diagram.

23. The markup page of claim 21, comprising further arrays that together with the first, second and third arrays form a reservoir.

24. The markup page of claim 21 in any language selected from the group of HTML, XML and JavaScript.

25. Computer system with server computer and client computer, wherein the server computer sends a markup page to the client computer and wherein the client computer interprets the page by a browser to provide an on-screen diagram, the system characterized in that the server computer inserts into the page,
a first array with a first number set (n);
a second array with a second number set (q);
a third array with a third number set (t), wherein the first set (n) and third set (t) form a first function (n=f(t)) and the second set (q) and the third set (t) form a second function (q=f(t));
selector code for providing a selector into the page, the code for interacting with a user of the client computer to receive a selection of selectively the first and the second function; and
diagram code for providing the diagram for the first function or for the second function depending on the selection.

26. The computer system of claim 25 wherein the server computer inserts display code for displaying a box indicating a particular number when the user moves a pointing device over the diagram, wherein the particular number corresponds to the position of the pointing device in the diagram.

27. The computer system of claim 25 wherein the server computer inserts modification code that when activated by the user, executes an action selected from the group of stretching a coordinate axis of the diagram, shrinking a coordinate axis of the diagram, scaling the numbers in the first array, second array or third array, setting start and end border for limiting display to sub-sets of the functions, and provide linear-to-logarithmic or logarithmic-to-linear conversion.

28. The computer system of claim 25 wherein the server computer cooperates with an application having functions with arrays selected from the group of: stock price, call numbers, monetary value, temperature, date, hour, nominal number, ordinal number.

29. The computer system of claim 25 wherein the server computer inserts diagram code for a Cartesian coordinate system or for a polar coordinate system.

30. The computer system of claim 25 wherein the server computer sends a code portion of the page with the selector code and with the diagram code, and sends a data portion of the page with the arrays.

31. The computer system of claim 30 wherein the server computer sends code portions and data portion at different time points.

32. The computer system of claim 30 wherein the server computer sends the code portion prior to the data portion.

33. The computer system of claim 30 wherein the server computer resends the data portion upon receiving a request from the client computer.

34. The computer system of claim 30 wherein the server computer resends the data portion periodically.

35. The computer system of claim 30 wherein the server computer resends data portion upon detecting a predefined condition.

36. The computer system of claim 30 wherein the server computer inserts diagram code for a reference graph with further number sets.

37. The computer system of claim 36 wherein the server computer inserts diagram code for the reference graph distinguishes from the selected function by line style, color, texture, or shape.

38. The computer system of claim 30 wherein the server computer inserts first, second and third array comprises to insert further arrays to form a reservoir.

39. A computer program product embodied on a computer usable medium, the computer program product comprising:
instructions to provide a markup page;
instructions to send the markup page;
instructions to insert into the page, a first array with a first number set (n), a second array with a second number set (q), a third array with a third number set (t), wherein the first set (n) and third set (t) form a first function (n=f(t)) and the second set (q) and the third set (t) form a second function (q=f(t));
instructions to insert selector code into the page, for providing a selector, the selector code for interacting with a user to receive a selection of selectively the first and the second function;
instructions to insert diagram code into the page, for providing a diagram for the first function or for the second function depending on the selection; and
instructions to display a diagram on a screen.

40. The computer program product of claim 39, further comprising instructions to insert display code for displaying a box that indicates a particular number when the user moves a pointing device over the diagram, wherein the particular number corresponds to the position of the pointing device in the diagram.

41. The computer program product of claim 39, further comprising instructions to insert modification code into the page that when activated by the user, executes an action selected from the group of stretching a coordinate axis of the diagram, shrinking a coordinate axis of the diagram, scaling the numbers in the first array, second array or third array, and setting start and end borders for limiting display to sub-sets of the functions, and provide linear-to-logarithmic or logarithmic-to-linear conversion.

42. The computer program product of claim 39, wherein the instructions to insert array use arrays that are selected from the group of stock price, call number, monetary value, temperature, date, hour, nominal number and ordinal number.

43. The computer program product of claim 39, wherein the instructions to insert diagram code comprise instructions to insert code for a Cartesian coordinate system or for a polar coordinate system.

44. The computer program product of claim 39, wherein the instructions to insert diagram code comprise instructions to insert code for visualizing a scale by a reference to a graphic image file.

45. The computer program product of claim 39, wherein instructions to send the page, further comprise:
sending a code portion of the page with the selector code and with the diagram code; and
sending a data portion of the page with the arrays.
